(19) United States
(12) Patent Application Publication
(10) Pub. No.: US 2008/0095941 A1
(43) Pub. Date: Apr. 24, 2008

(54) Overlapping fabric print technique for tee-shirts

(76) Inventor: Fleurette May Khatzis, Montebello, CA (US)

Correspondence Address: Fleurette Khatzis, 544 N.7th Street, Montebello, CA, 90640, US

(21) Appl. No.: 11/515,189

(22) Filed: Sep. 5, 2006

(51) Int. Cl. B05D 5/06

(52) U.S. Cl. 427/288

(57) ABSTRACT

The technical aspect of the invention is the printmaking process. The original designs by me are rendered in a style conducive to making a stencil or stencils depending on the number of colors to be used in the print. Each design is carefully plotted to create a first and second image when the design is partially folded over itself approximately 1½ inches.

### CROSS REFERENCE TO RELATED APPLICATIONS

The utility patent applied for in this application uses various print designs previously copyrighted by me, Fleurette Khatzis. The design used in the drawings for this application is titled “Rose-winged Dragon” and the copyright is REGISTRATION NUMBER Vau 628-221 Effective Date of Registration Jun. 7, 2004.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention follows the popular trend to wear shirts with printed designs. This invention is a new and novelty way to display art work printed on garments using a double image. This technique has not been used on tee-shirts prior to my invention.

### BRIEF SUMMARY

The utility patent is for the overlapping technique to be used for printing on fabric, espicially tee-shirts. The original designs used in this process have been previously copyrighted by me and are not part of this claim. The “Rose-winged Dragon” used in the following drawings is used as a sample only to show the use of the overlapping technique in this invention.

### BRIEF DESCRIPTION OF THE SEVERAL VIEWS OF THE DRAWING

FIG. 1A is a frontal view of a tee-shirt with one of my original designs as it appears as printed including 2 sets of small printed diamond marks to indicate to the wearer where to fold the shirt to make a second image appear. The print is titled “Rose-winged Dragon” and the image is of a coiled dragon with wide spread wings bearing roses.

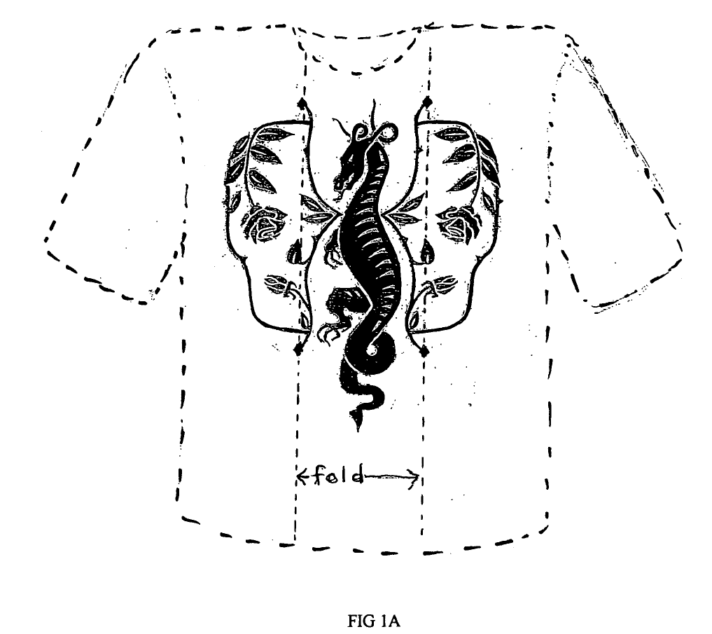

FIG. 1B is a frontal view of the same shirt as in FIG. 1A with the “Rose-winged Dragon” overlapped at the printed diamonds by the wearer to reveal a second image of a skull formed from the wings.

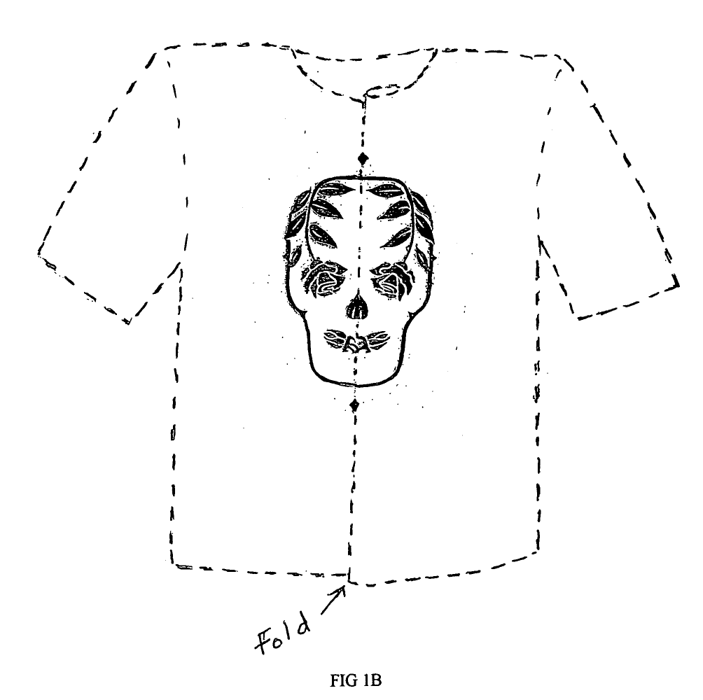

### DETAILED DESCRIPTION OF THE INVENTION

The invention entails the printing of original copyrighted designs by me, Fleurette Khatzis, on wearable tee-shirts. The original designs are submitted to textile printers. An appropriate stencil or stencils are made for silk-screen process or other fabric print methods. The designs are then printed using fabric dyes or inks to print design on front of tee-shirts of assorted sizes, colors, and lengths. Each design has the potential to make a second image when the wearer folds the original design partially over itself approximately 1½ inches. The fold is indicated on the tee-shirt with a set of 2 small printed marks included in the design. The wearer simply grasps the shirt, aligns the marks by overlapping and the second image appears. The tee-shirt is released and the original design reappears.

1. This utility patent is specifically for the technique of printing overlap designs on tee-shirts
Original designs are copyrighted
Designs show original image when printed on tee-shirt
Designs have small printed marks to indicate where to overlap
Second image appears when wearer folds over shirt at printed marks
